(19) United States
(12) Patent Application Publication
(10) Pub. No.: US 2011/0040989 A1
(43) Pub. Date: Feb. 17, 2011

(54) SYSTEMS AND METHODS FOR MANAGING POWER CONSUMPTION OF MOBILE COMPUTING DEVICES

(76) Inventor: David Keyes Keyes, Clinton, OH (US)

Correspondence Address: ULMER & BERNE LLP;ATTN: DIANE BELL, 600 VINE STREET, SUITE 2800, CINCINNATI, OH, 45202, US

(21) Appl. No.: 12/821,037

(22) Filed: Jun. 22, 2010

Related U.S. Application Data
(60) Provisional application No. 61/219,345, filed on Jun. 22, 2009.

(51) Int. Cl. G06F 1/00; G06F 1/26

(52) U.S. Cl. 713/300

(57) ABSTRACT

A method for managing power consumption of a mobile computing device includes setting a minimum orientation and a maximum orientation for the mobile computing device, and determining a relative orientation of the mobile computing device. The relative orientation of the mobile computing device is compared to the minimum and maximum orientations. Whether to allow for the mobile computing device to be suspended is determined based on comparisons of relative orientation to the minimum and maximum orientations. A mobile computing device includes a power source and a sensor configured to determine a relative orientation of the mobile computing device. The mobile computing device further includes a means for determining if the relative orientation of the mobile computing device is greater than a minimum orientation and less than a maximum orientation, and a means for inhibiting a suspension protocol for the mobile computing device.

### CROSS-REFERENCE TO RELATED APPLICATIONS

This application claims the priority of U.S. Provisional Patent Application Ser. No. 61/219,345 filed Jun. 22, 2009, titled “A SYSTEM AND METHOD FOR CONTROLLING THE POWER-SAVING FEATURES OF A MOBILE COMPUTING DEVICE BASED ON ORIENTATION OF THE DEVICE,” which is hereby incorporated by reference herein in its entirety.

### TECHNICAL FIELD

The disclosed systems and methods relate generally to the field of managing the power consumption of a mobile computing device and more particularly to managing power consumption of a mobile computing device based on a determination of a spatial orientation of the mobile computing device.

### BACKGROUND

Mobile computing devices such as mobile phones, electronic book readers, smart phones, and laptops are becoming increasingly more sophisticated and offer increased functionality to users of these devices. Increases in functionality can lead to greater demands for electrical power to operate mobile computing devices. By their very nature, mobile computing devices cannot rely on stationary and continuous sources of electrical power and, thus, require a portable source of electrical power such as batteries to function and operate. Often, such mobile computing devices include mechanisms for managing consumption of battery power. Such mechanisms can include features that suspend operation of the device when the device is inactive or otherwise not in use.

### SUMMARY

In one embodiment, a method for managing power consumption of a mobile computing device is provided. The method includes setting a minimum orientation for a mobile computing device, setting a maximum orientation for the mobile computing device, and determining a relative orientation of the mobile computing device. The method further includes comparing the relative orientation of the mobile computing device to the minimum orientation and comparing the relative orientation of the mobile computing device to the maximum orientation. The method further includes determining whether to allow an operation of the mobile computing device to be suspended based on comparisons of the relative orientation with respect to both the minimum orientation and the maximum orientation.

In another embodiment, a method for detecting passive use of a mobile computing device is provided. The method includes sensing an orientation of a mobile computing device relative to a plane perpendicular to a gravitational vector. The method further includes quantifying the orientation of the mobile computing device to determine an orientation value, comparing the orientation value to a preset minimum value, and comparing the orientation value for a preset maximum value. The method further includes preventing a mobile computing device suspension protocol for executing when the orientation value is greater than the minimum value and is less than the maximum value.

In another embodiment a mobile computing device is provided. The mobile computing device includes a power source configured to store electrical power and a sensor configured to determine a relative orientation of a mobile computing device. The mobile computing device further includes a means for setting a minimum orientation and a means for setting a maximum orientation. The mobile computing device further includes a means for determining if the relative orientation of the mobile computing device is greater than the minimum orientation and less than the maximum orientation and a means for inhibiting a suspension protocol for the mobile computing device if the relative orientation of the mobile phone is greater than the minimum orientation and less than the maximum orientation.

### BRIEF DESCRIPTION OF THE DRAWINGS

It is believed that certain examples will be better understood from the following description taken in combination with the accompanying drawings in which:

FIG. 1 is a schematic perspective view of a smart phone;

FIG. 2 is a schematic perspective view of an electronic book reader;

FIG. 3 is a schematic perspective view of the electronic book reader of FIG. 2 positioned in portrait mode and shown at a pitch angle A;

FIG. 4 is a schematic perspective view of the electronic book reader of FIG. 2 positioned in landscape mode and shown at a pitch angle B;

FIG. 5 is a schematic perspective view of the electronic book reader of FIG. 2 positioned in landscape mode and shown at roll angle C;

FIG. 6 is a flow chart illustrating a method for managing the power consumption of a mobile computing device; and

FIG. 7 is a continuation of the flow chart of FIG. 6.

### DETAILED DESCRIPTION

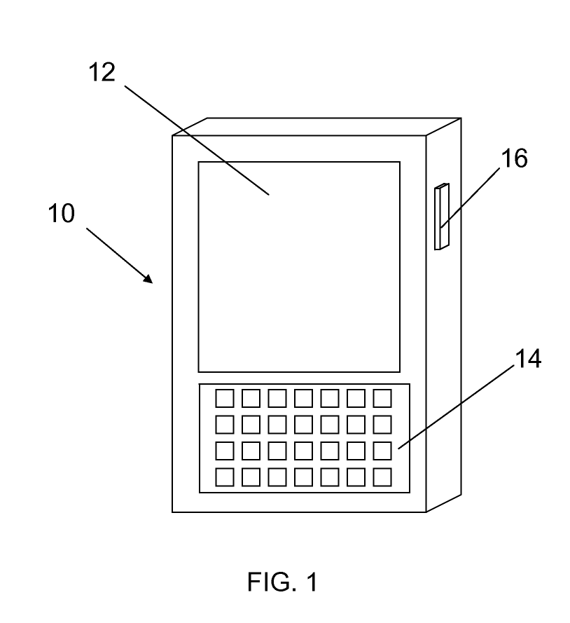

The systems and methods disclosed and described in herein are disclosed and described in detail with the views and examples of the included figures. Unless otherwise specified, like numbers in the figures indicate references to the same or corresponding elements throughout the views of the figures. Those of ordinary skill in this art will recognize that modifications to disclosed and described components, elements, methods, etc. can be made and may be desired for a specific application. In this disclosure, any identification of specific arrangement, configuration, technique, method, and the like is either related to a specific example presented or is merely a general description of such an arrangement, configuration, technique, method, etc. Identification of specific details are not intended to be and should not be construed as mandatory or limiting unless specifically designated as such. Selected examples of systems and methods for managing the power consumption of a mobile computing device are hereinafter disclosed and described in detail with reference made to FIGS. 1 through 7.

An exemplary mobile computing device 10 is illustrated in FIG. 1. The mobile computing device 10 illustrated is a smart phone. The smart phone 10 can include a display screen 12, a keyboard 14, and functional button 16. The display screen 12 can display content to a user of the smart phone 10 such as, for example, an electronic mail received by the smart phone 10, a web page downloaded to the smart phone 10, or a document downloaded or stored on the smart phone 10. In one example, the display screen 12 can be a touch screen such that the smart phone 10 can receive commands and other selections through the user touching the display screen 12. The keyboard 14 can be utilized by the user for a variety of functions, including creating an electronic mail or editing a document. In one example, the functional button 16 can be an on/off switch. It will be understood that the arrangement of the smart phone 10 as shown in FIG. 1 is exemplary only, and a smart phone or other mobile computing device can include a number of other features such as multiple functional keys, a keyboard displayed via a touch screen, a trackball, a mouse, and any number of other suitable features. It will be appreciated that a mobile computing device can include a variety of devices, including for example a smart phone, an electronic book reader, tablet, media player, or any other computer-based portable devices.

Mobile computing devices such as the smart phone 10 can include an internal power source (e.g. a battery) to store and/or provide electrical power to the mobile computing device. Electrical power can facilitate the general operation of the mobile computing device and can also facilitate specific and individual operations of a mobile computing device. For example, an internal battery can provide electrical power to generally start-up or boot-up a mobile computing device. In another example, an internal battery can also provide electrical power to facilitate specific operations of a mobile computing device such as illuminating a display screen, emitting an audible tone, executing code on an internal processor, accepting input through a touch screen, trackball, or keyboard, or any other suitable input devices, and many other suitable operations.

A mobile computing device can be configured to manage the power consumed by the mobile computing device. For example, the smart phone 10 can be configured so that general operation of the smart phone 10 is suspended when the smart phone 10 is not in use for a predetermined amount of time. This is to say that the smart phone 10 is powered down when the smart phone 10 has been inactive for the predetermined period of time, thus, conserving the electrical power of the battery.

In another example, the smart phone 10 can be configured to suspend a specific operation of the smart phone 10 when the smart phone 10 has been inactive for a predetermined period of time. For example, electric power that is normally directed to the display screen 12 to illuminate the display screen 12 can be suspended after the smart phone has been idle for a first period of time. In this example, the display screen 12 becomes dormant, and electrical power can be returned to illuminate the display screen 12 when the smart phone 10 is again in use. In another example, power directed to an internal processor can be suspended when it is determined that the smart phone 10 has been idle for a second period of time. Code being executed by an internal processor ceases or is idled and electrical power can be returned to the internal processor when the smart phone 10 is again in use.

A mobile computing device can be configured such that the user of the device can set the first time period and the second time period. These time periods can also be preset statically based on the type and intended use of the device, or these time periods can be dynamically set based on the use history of the device or the current use of the device by the user. The first time period and the second time period can be of equal or varying lengths and can be set concurrently or independently.

Whether a mobile computing device is in use or idle can be determined through any number of suitable methods. In one example, the smart phone 10 (as shown in FIG. 1) can be configured so that the smart phone 10 monitors a number of “indicators of use.” Examples of indicators of use include the user typing on the keyboard 14, the user touching or otherwise interacting with the touch screen 14, and the user moving a mouse or trackball. The smart phone 10 can be configured such that an absence of such indicators of use for a specified and configurable period of time initiates a suspension of one or more operations of the smart phone 10, thus, conserving battery power.

A method, arrangement, or configuration that suspends an operation of a mobile computing device after a period of time can be referred to as a suspension protocol. Such suspension protocols can include, for example, configurable time periods, can be initiated by any number of suitable inputs, can be at least partially facilitated by hardware or software, and can be arranged to suspend any number of suitable operations of the mobile computing device.

A user of a mobile computing device can also use the device without performing any of the tactile indictors of use described above. As mobile computing devices increase in sophistication and functionality, it is becoming more common for a user to read long textual passages on such devices without any physical interaction with a touch screen, keyboard, trackball, mouse, or other feature of the device.

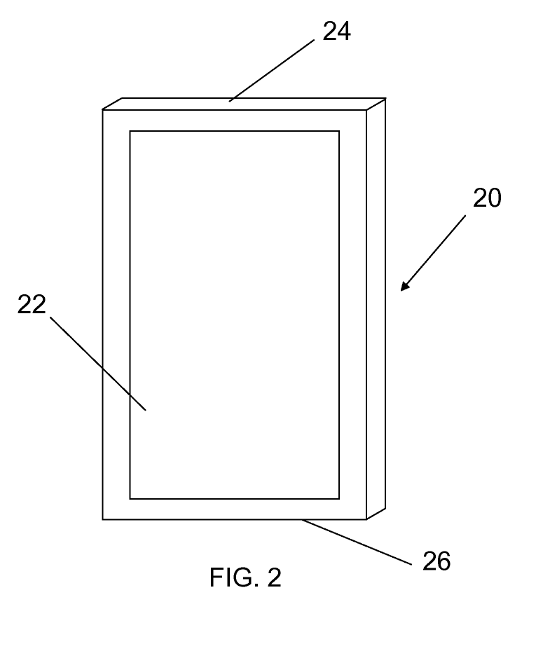

For example, as illustrated in FIG. 2, mobile computing devices such as electronic book readers 20 are designed so that users can read long textual passages without much active interaction with the mobile computing device. The electronic book reader 20 includes a relatively large display screen 22, which can display a long passage from an electronic book that can require several minutes of uninterrupted reading before the user can move on to other content. Such a use of a mobile computing device can be referred to as passive use or passive activity. With regard to the smart phone 10 of FIG. 1, a user can use the smart phone 10 for any number of suitable passive activities. For example, the smart phone 10 can display a lengthy electronic mail, text from a web page, a text message, or a document on its display screen 12. The user may require several minutes or more to read and contemplate the displayed content without actively manipulating the touch screen 12, keyboard 14, functional button 16, or other features of the smart phone 10.

For passive uses of mobile computing devices, it can be inefficient to suspend an operation of the mobile computing device after a predetermined period of time without the detection of a tactile indicator of use. For example, for the smart phone 10 and the electronic book reader 20, suspending electrical power to the display screen 12, 22 after the predetermined period of time can inhibit the user from completing the passive activity. When the display screen 12, 22 becomes dormant, the user may have to repeatedly provide a tactile indicator of use to initiate a return of electrical power to illuminate the display screen 12, 22.

As will be described, a mobile computing device can be configured to detect passive use of the device by a user. When passive use is detected, a mobile computing device can be configured to prevent or inhibit a suspension protocol, i.e., prevent the suspension of an operation of the device when no tactile indicator of use has been detected for a predetermined period of time. Such prevention can provide for the operation of the device to remain continuously active to accommodate the passive use of a device. In addition, the mobile computing device can be configured to provide feedback to the user of the device to indicate when passive use has been detected.

In one example, passive use or activity is detected by determining the spatial orientation of a mobile computing device and comparing that spatial orientation to predetermined parameters associated with passive activities. When a user engages in passive activities, such as reading content displayed on the electronic book reader 20, the electronic book reader 20 is commonly held within a range of recognizable spatial orientations. For example, when the user is seated or standing and reading a passage on the electronic book reader 20, it can be common for the user to hold the electronic book reader 20 within a given range of angles relative to the user. For example, it is common for the user to hold the electronic book reader 20 so that a top portion 24 of the electronic book reader 20 is positioned above a bottom portion 26 of the electronic book reader 20, and the top portion 24 is positioned further away from the user than the bottom portion 26.

The electronic book reader 20 can be configured to detect and quantify the orientation of the electronic book reader 20 and compare it to a predetermined range of orientations. If the orientation is within a predetermined range, it is determined that the electronic book reader 20 is being used passively and one or more operations of the electronic book reader 20 are prevented from being suspended, i.e., one or more suspension protocols are inhibited. Conversely, if it is determined that the orientation of the electronic book reader 20 is not within the predetermined range, it is determined that the electronic book reader 20 is not being used passively. Provided there are no other indications of use over a predetermined period of time, one or more operations of the electronic book reader 20 can be suspended as determined by suspension protocols.

Mobile computing devices can include one or more sensors useful in determining the spatial orientation of the device. In one example, the electronic book reader 20 can be equipped with one or more accelerometers. In another example, the electronic book reader 20 can be equipped with one or more gyroscopes. Sensors such as accelerometers can be configured to detect forces of acceleration acting on mobile computing devices. For example, an accelerometer can be configured to detect the force of earth's gravitational pull acting on the electronic book reader 20, i.e., the gravitational vector. Once the gravitational vector is detected, the accelerometer and/or the electronic book reader 20 can be configured to determine the spatial orientation of the electronic book reader 20.

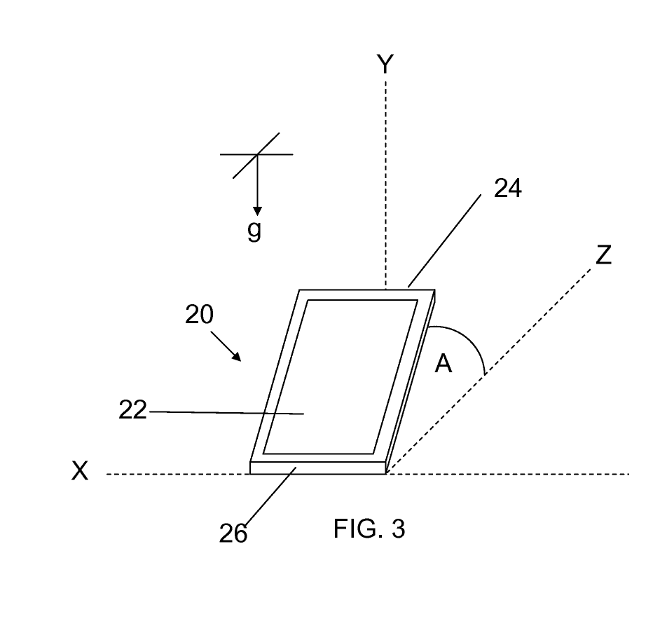

FIGS. 3-5 illustrate spatial orientation for a mobile computing device. As illustrated in FIGS. 3-5, the gravitational vector (g) represents the direction and magnitude of the earth's gravitational force with respect to the electronic book reader 20. The three-dimensional space surrounding the electronic book reader 20 will be described in context of the gravitational vector (g). A Y-axis is generally oriented vertically, i.e., parallel the gravitational vector (g). An X-axis and a Z-axis are both perpendicular to the Y-axis and, thus, perpendicular to the gravitation vector (g). In addition, the X-axis and Z-axis are perpendicular to each other and jointly define a plane that is perpendicular to the gravitational vector (g) and generally parallel to the earth's surface, colloquially referred to as “the ground.”

As shown in FIG. 3, the electronic book reader 20 can be oriented at an angle A relative to the Z-axis. It will be understood that the electronic book reader 20 is also considered to be at the angle A to the plane that is perpendicular to the gravitational vector (g), also referred to as the ground. Such an orientation is useful to a user that is reading text on the display screen 22 of the electronic book reader 20. Such an orientation provides for the top portion 24 of the electronic book reader 20 to be positioned above the bottom portion 26 of the electronic book reader 20, and the top portion 24 to be positioned further away from the user than the bottom portion 26.

The general orientation of the electronic book reader 20 as shown in FIG. 3, i.e., the top portion 24 of the electronic book reader 20 being above the bottom portion 26 of the electronic book reader 20, can be referred to as portrait mode. It will also be understood that the electronic book reader 20, as well as other mobile electronic devices, can also be arranged such that the electronic book reader 20 is also referred to as being in portrait mode when the bottom portion 26 of the electronic book reader 20 is above the top portion 24 of the electronic book reader 20. The angle A can be referred to as the pitch of the electronic book reader 20 when it is in portrait mode. The electronic book reader 20 can be configured to calculate or otherwise quantify angle A, i.e., determine a numerical value for the pitch of the electronic book reader 20 in portrait mode.

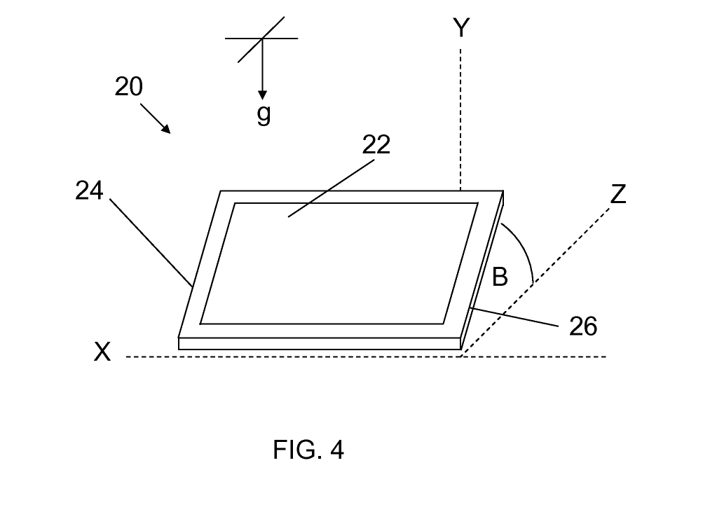

In another example illustrated in FIG. 4, the electronic book reader 20 can be generally rotated 90 degrees from the orientation as show in FIG. 3 so that the top portion 24 and the bottom portion 26 of the electronic book reader 20 are generally co-positioned relative to the Y-axis. Such an orientation can be referred to as landscape mode. Although FIG. 4 illustrates the top portion 24 of the electronic book reader 20 to the left and the bottom portion 26 of the electronic book reader 20 to the right with respect to FIG. 4, it will be understood that if this arrangement is reversed, the electronic book reader 20 could also be referred to as being in landscape mode. This landscape mode configuration can also be useful in facilitating the reading of text or other content on a mobile computing device. Mobile computing devices can be configured to determine whether the device is being held in portrait mode or landscape mode and arrange content on the display screen accordingly.

Referring again to FIG. 4, the electronic book reader 20 is shown in landscape mode and is positioned at an angle B relative to Z-axis. It will be understood that the electronic book reader 20 is also considered to be at the angle B relative to the ground. The electronic book reader 20 can be configured to determine if it is in portrait mode or landscape mode. If it determines that it is in landscape mode, the electronic book reader 20 can be configured to calculate or otherwise quantify the angle B, i.e., determine a numerical value for the pitch of the electronic book reader 20 in landscape mode.

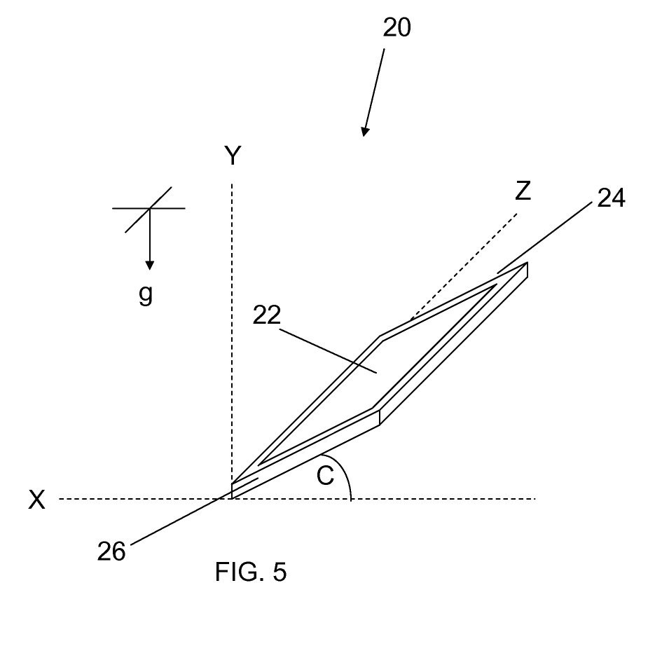

In another example, the electronic book reader 20 can be configured so that the pitch is quantified only when the electronic book reader 20 is in portrait mode. When the electronic book reader 20 is in landscape mode, the electronic book reader 20 is configured to calculate or otherwise quantify the “roll” of the electronic book reader 20. As shown in FIG. 5, when the electronic book reader 20 is held in landscape mode, it can be oriented such that it is at an angle C relative to the X-axis. It will be understood that the electronic book reader 20 is also considered to be at the angle C relative to the ground. The electronic book reader 20 can be configured to calculate or otherwise quantify to angle C, i.e., determine a numerical value for the roll of the electronic book reader 20 in landscape mode.

In one example, a mobile computing device can be configured as follows to quantify the spatial orientation of the device. A mobile computing device can include a sensor, such as an accelerometer. A sensor can be configured to sense the gravitational vector. A determination of the magnitude of the gravitational vector and an understanding of the sensor orientation with respect to the device can result in the sensor and/or the device determining whether the device is being held or otherwise positioned in portrait mode or landscape mode. Once this determination is made, the magnitude of the gravitational vector sensed by a sensor can be converted through mathematical formulas to a numerical value for either the pitch of the device, the roll of the device, or both.

As will be further discussed, the quantification of pitch angles A or B or roll angle C can be used to determine if a mobile computing device is being passively used. For example, a minimum value and a maximum value can be assigned to pitch angles A or B or to roll angle C to represent a lower limit and an upper limit of these values that correlate to passive use of the mobile computing device. It will be understood that minimum and maximum values can be assigned to only one of the angles, two of the angles, or all of the angles. In addition, the minimum value and maximum value for each angle can be assigned independently. It also will be understood that minimum and maximum values for the angles can be assigned statically with predetermined values that are considered appropriate for a specific mobile computing device. The values can also be assigned dynamically based on observed user behavior. Furthermore, the values can be assigned by the user based on the user's preferences and an understanding of how the user handles and uses a mobile computing device.

In one example, a mobile computing device can be configured to determine the presence of passive use as follows. A sensor or the sensor working in combination with other functionality of the mobile computing device quantifies one or more of the pitch angles A and B and roll angle C, i.e., determines a numerical value for one or more angles. For each angle quantified, the numerical value can be compared to the predetermined minimum value and maximum value for the angle. If the quantified value is between the minimum and maximum value for the angle, it can be determined that a mobile computing device is being used passively. A mobile computing device can be configured to prevent or inhibit any suspension protocols that will suspend any operation of the device due to lack of detecting an indicator of use. When the mobile computing device inhibits a suspension protocol, the mobile computing device can be said to have obtained a “wake-lock.” This is to say that the mobile computing device is locked in an awake state.

If a quantified value for an angle is below the minimum value for the angle or is above the maximum value for the angle, it can be determined that a mobile computing device is not being used passively. A mobile computing device can be configured to allow or permit any suspension protocol to suspend any operation of the device under the terms of the suspension protocol. If a mobile computing device has previously obtained a wake-lock, the device can be configured to release that wake-lock and, thus, allow or permit suspension protocols to proceed. In one example, a mobile computing device can be configured such that only one angle is quantified to determine if the device is being used passively. In another example, a mobile computing device can be configured such that it quantifies more than one angle to determine if the device is being used passively.

Although the description and figures make reference to two pitch angles A and B and a roll angle C, it will be understood that any number of suitable parameters can be used to determine orientation of a mobile computing device.

The mobile computing device can be configured so that a visual, audible, or other suitable tactile indicator is provided to the user to indicate to the user when the device is in an orientation that will prevent or inhibit suspension protocols, i.e., being used passively. In one example, an icon representing the detection of passive use can be displayed on the display screen. In another example, a light (e.g. a light emitting diode) can be pulsed to inform the user that passive activity has been detected. In yet other examples, the mobile computing device can emit a recognizable audible tone, a device can produce a short pulse to vibrate the device, or deliver any other recognizable indication to the user.

As previously described, the user is able to configure the range of orientations that will prevent or inhibit suspension protocols. For example, when using the smart phone 10 mostly to make calls, the user can define narrow ranges of orientation so that the display screen 12 is more readily suspended when the user is on a call to conserve battery power. If the user is using the smart phone 10 mostly to read text on the display screen 12, the user can define broad ranges of orientation so that the display screen 12 is not readily suspended when the user is reading text on the display screen 12.

A mobile computing device can also be configured to detect false determinations of passive activity. A mobile computing device can be stored by the user in an orientation that is between the predetermined values assigned to the minimum orientation (or minimum angle) and the maximum orientation (or maximum angle). For example, the smart phone 10 can be placed at an angle in a cup holder in an automobile and remain there for long periods of time. The battery power can be more effectively managed if this condition were determined to be a false determination of passive activity, and a wake-lock is either not obtained or released. The mobile computing device can be configured to determine the length of time the device remains in a static orientation. Even when a user is engaged in passive activity, the user tends to reposition the device from time to time. If it is determined that a mobile computing device has been maintained in a static orientation for a configurable period of time, the mobile computing device can determine that passive activity was falsely detected. The configurable period of time can be referred to as “stillness time.”

When a mobile computing device remains in a static orientation for a period of time that exceeds the stillness time, the device can deliver some indication to the user that represents the intention to shortly release any wake-lock and allow the device to be subject to any suspension protocols. Such indication can be delivered via a visual, audible, or tactile indicator to indicate that the detection of passive activity will “timeout.” If a user is engaged in passive use of the device, the user can take note of the indicator and move the device slightly to avoid suspension of the device. If no change in orientation is detected within a configurable period after the warning, the wake-lock will be released and the operations of the device can be subject to suspension protocols. The configurable period of time can be referred to as “wake-lock release time.”

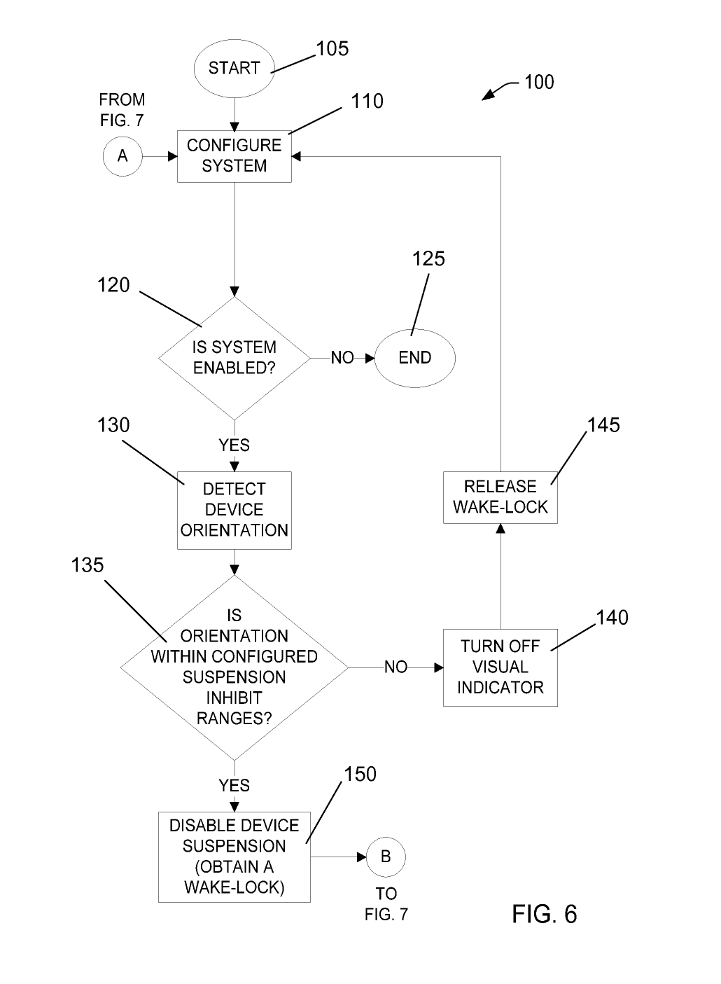

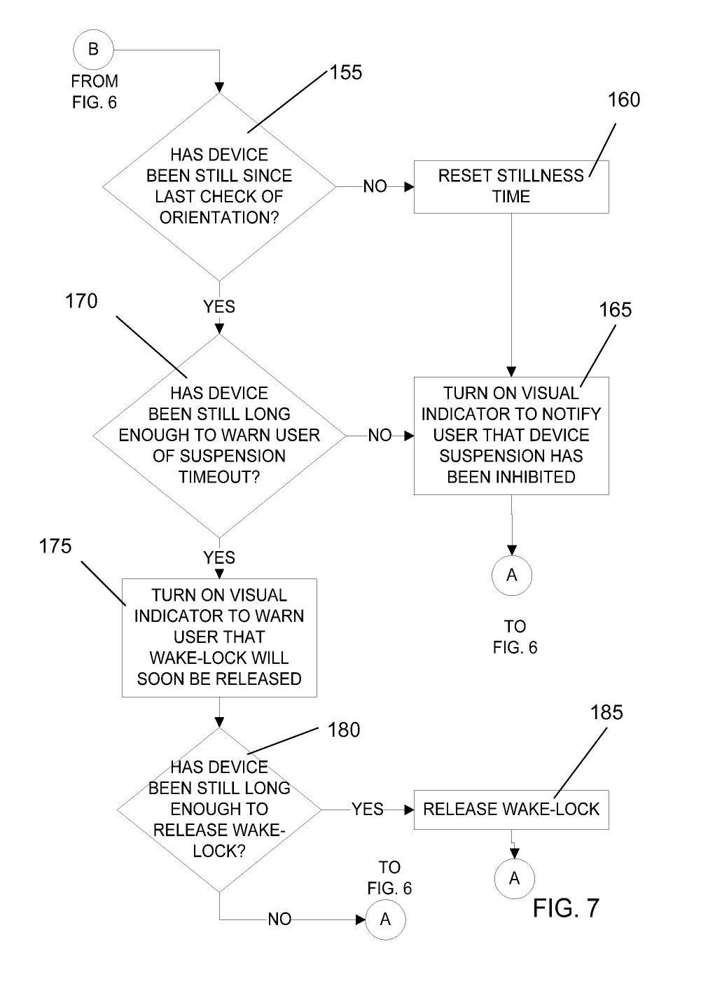

A method 100 for managing the power consumption of a mobile computing device is illustrated in FIGS. 6 and 7. An orientation of a mobile computing device can be quantified and utilized in determining whether to prevent or inhibit any suspension protocols for the mobile computing device. The method 100 starts 105 by configuring the system 110. The system can be configured 110 by defining any number of suitable parameters. In one example, the system is configured by defining minimum and maximum values for characteristic that can indicate whether the mobile computing device is being used passively. For example, minimum and maximum values can be defined for one or more pitch angles or a roll angle for a device. In another example, values can be defined for stillness time and wake-lock release time.

In one example the minimum value for a pitch angle that can indicate passive use of the device is defined as about 5 degrees. The maximum value for a pitch angle that can indicate passive use of the device is defined as about 70 degrees. Thereby, when the mobile computing device quantifies a pitch as between about 5 degrees and about 70 degrees, it can be determined that passive activity is ongoing. Therefore, suspension protocols for the mobile computing device can be prevented or inhibited. In another example, the minimum value for a roll angle that indicates passive use of the device is defined as about 5 degrees. The maximum value for a roll angle that indicates passive use of the device is defined as about 65 degrees. Thereby, when the mobile computing device quantifies a roll as between about 5 degrees and about 65 degrees, it can be determined that passive activity is ongoing. Therefore, suspension protocols for the mobile computing device can be prevented or inhibited. As indicated above, these ranges can be modified to more appropriately serve the needs of the user of a mobile computing device.

Other parameters that can be defined during the configuration of the system 110 include the types of indicators the device will use to inform the user that a wake-lock has been obtained or to warn the user that a false determination of passive activity has been detected.

After the system is configured 110, the method 100 determines if the system is enabled 120. In one example, the system can be enabled manually through a user input. A mobile computing device can be configured so that the system is enabled automatically at the time the mobile computing device is started-up or booted-up. The system can also be enabled by a predefined user behavior. If the system is not enabled, the method 100 ends 125. If the system is enabled, the method 100 detects the orientation of the mobile computing device 130. The method 100 can be provided with data indicating the spatial orientation of the device in three-dimensional space to calculate or otherwise quantify the orientation of the device. As described above, in one example, at least one accelerometer can be used with the mobile computing device to provide such orientation data to the method 100. It will be understood that in addition to accelerometers, other sensors and sensory devices can be used to determine or quantify pitch or roll or other appropriate indicators or parameters of spatial orientation.

Once the orientation is detected, the orientation can be evaluated 135. In evaluating the orientation, the method 100 can determine if the mobile computing device is within the range defined during the configuration of the system 110, i.e., is the orientation greater than a defined minimum orientation and less than a defined maximum orientation. If it is determined that the orientation is not within the defined range, the method 100 will not prevent or inhibit any suspension protocol from suspending an operation of a mobile computing device. The method 100 can then determine if an indicator of passive use is “ON.” If the indicator is “ON,” the indicator is turned “OFF” 140. The method 100 can then determine if a wake-lock was previously obtained. If the wake-lock was obtained, the wake-lock can be released 145, and the method 100 returns to the step of system configuration 110.

When the method 100 first executes the step of configuring the system 110 after the method 100 starts 105, parameters can be dynamically or statically defined. Such parameters can be loaded from memory or defined by a user. When the method 100 returns to the step of configuring the system 110, the method 100 can determine if any parameters have been changed. If a parameter has been changed, the method 100 can accept the change. In another arrangement of a method for managing the power consumption of a mobile computing device, instead of returning to a step of system configuration, the method can return to the step of detecting the device orientation.

Returning to step 135 of FIG. 6, if it is determined that the orientation is within any of the ranges configured for the system, the method 100 can obtain a wake-lock 150, i.e., prevent or inhibit suspension protocols for the mobile computing device from suspending an operation of the device. In one example, the method 100 will prevent or inhibit any suspension protocol from suspending power to the display screen of the device. Therefore, the display screen will remain active and illuminated to facilitate passive use of the device.

The method 100 next detects whether the mobile computing device has remained substantially still since the last orientation check 155. As previously described, such a check can detect a false determination of passive use of the mobile computing device. The method 100 can be configured to be sensitive enough to detect small movements of the device by the user. If there is no movement detected, the device may have been positioned such that it is within the minimum and maximum orientation range, but there is no passive activity occurring. If it is determined that the device was not still, i.e., movement was detected, the stillness time is reset to zero 160. Once the stillness time is reset to zero 160, an indictor can be turned “ON” to notify the user that suspension protocols have been inhibited 165. The method then proceeds to the system configuration step 110. As will be understood, in one example of a method for managing the power consumption of a mobile computing device, the method can proceed to detecting the device orientation.

If it is determined that the device was still, i.e., no movement is detected, the method 100 can determine whether the orientation has remained substantially unchanged for at least as long as the stillness time 170. If the device has indeed remained still for at least as long as the stillness time, then the user can be given a notification that the wake-lock will soon be released 175. Similar to previous descriptions, the notification can be visual, audible, tactile, etc. The user can prevent the wake-lock from being released by manually moving or adjusting the orientation of the device.

The method 100 then determines if the orientation has remained unchanged for at least as long as the wake-lock release time 180. The wake-lock release time can provide an opportunity for the user to take note of the notification that the wake-lock will soon be released, and allows the user to take action to stop the wake-lock from being released. For example, the user can change or adjust the orientation of the device. If the orientation remains substantially unchanged for the wake-lock release time, the wake-lock can be released 185, and device suspension protocols will no longer be prevented or inhibited. If the orientation has not changed during the wake-lock release time, the method 100 proceeds to the system configuration step 110. As will be understood, in one example of a method for managing the power consumption of a mobile computing device, the method can proceed to detecting the device orientation.

It will be understood that the systems and methods described and disclosed herein can be configured as software, hardware, or a combination of software and hardware. For example, code to facilitate certain functionality can be executed on an internal processor of a mobile computing device. Commands, instructions, selections, and the like can be entered via a keyboard, mouse, trackball, or other suitable hardware components. Computer chips or other similar hardware device can be encoded with instructions to execute certain functionality.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

What is claimed is:

1. A method for managing power consumption of a mobile computing device comprising:
setting a minimum orientation for a mobile computing device;
setting a maximum orientation for the mobile computing device;
determining a relative orientation of the mobile computing device;
comparing the relative orientation of the mobile computing device to the minimum orientation;
comparing the relative orientation of the mobile computing device to the maximum orientation; and
determining whether to permit an operation of the mobile computing device to be suspended based on comparisons of the relative orientation with respect to both the minimum orientation and the maximum orientation.

2. The method of claim 1, where:
the minimum orientation is defined as a first angle;
the maximum orientation is defined as a second angle; and
the relative orientation is defined as a third angle, where to third is an angle of the mobile computing device relative to a plane of reference.

3. The method of claim 2, further comprising:
inhibiting suspension of the operation of the mobile computing device when the third angle is greater than the first angle and the third angle is less than the second angle.

4. The method of claim 2, further comprising:
permitting suspension of the operation of the mobile computing device when the third angle is either less than the first angle or greater than the second angle.

5. The method of claim 3 further comprising:
determining whether the mobile computing device is in a portrait mode or in a landscape mode.

6. The method of claim 3 further comprising:
providing a first indicator to indicate that suspension of the operation of the mobile computing device has been inhibited.

7. The method of claim 3, further comprising:
setting a first period of time;
monitoring the third angle to detect a change in the third angle during the first period of time;
determining if the third angle has changed during the first period of time; and
permitting suspension of the operation of the mobile computing device when the third angle remains substantially unchanged during the first period of time.

8. The method of claim 7, further comprising:
delaying the permitting of the suspension of the operation of the mobile computing device for a second period of time; and
providing a second indicator to indicate the delay in the permitting of the suspension of the operation of the mobile computing device for a second period of time.

9. The method of claim 8, further comprising:
monitoring the third angle during the second period of time;
determining if the third angle has changed during the second period of time; and
inhibiting suspension of the operation of the mobile computing device when the third angle has changed during the second period of time.

10. The method of claim 1 further comprising:
adjusting one of the minimum orientation for the mobile computing device or the maximum orientation for the mobile computing device.

11. A method for detecting passive use of a mobile computing device, comprising:
sensing an orientation of a mobile computing device relative to a plane perpendicular to a gravitational vector;
quantifying the orientation of the mobile computing device to determine an orientation value;
comparing the orientation value to a preset minimum value;
comparing the orientation value for a preset maximum value; and
preventing a mobile computing device suspension protocol from executing when the orientation value is greater than the minimum value and less than the maximum value.

12. The method of claim 11, further comprising:
permitting adjustment of the preset minimum value or preset maximum value.

13. The method of claim 11, further comprising:
communicating that the mobile computing device suspension protocol is prevented from executing.

14. The method of claim 11, further comprising:
monitoring the orientation value.

15. The method of claim 14, further comprising:
determining when the orientation value is substantially static; and
permitting execution of the mobile computing device suspension protocol when the orientation value is substantially static.

16. The method of claim 14, further comprising:
determining when the orientation value becomes either greater than the maximum value or becomes less than the minimum value; and
permitting execution of the mobile computing device suspension protocol when the orientation value becomes less than the minimum value or greater than the maximum value.

17. A mobile computing device comprising:
a power source configured to store electrical power;
a sensor configured to determine a relative orientation of a mobile computing device;
a means for setting a minimum orientation;
a means for setting a maximum orientation;
a means for determining if the relative orientation of the mobile computing device is greater than the minimum orientation and less than the maximum orientation; and
a means for inhibiting a suspension protocol for the mobile computing device if the relative orientation of the mobile phone is greater than the minimum orientation and less than the maximum orientation.

18. The mobile computing device of claim 17, further comprising:
a means for activating the suspension protocol for the mobile computing device if the relative orientation of the mobile phone is greater than the maximum orientation or less than the minimum orientation.

19. The mobile computing device of claim 17, further comprising:
an indicator configured to indicate when the suspension protocol is inhibited.

20. The mobile computing device of claim 17, further comprising:
a means for activating the suspension protocol for the mobile computing device if the relative orientation of the mobile computing device remains substantially unchanged for a preset period of time.
